(19) United States
(12) Patent Application Publication
(10) Pub. No.: US 2024/0212008 A1
(43) Pub. Date: Jun. 27, 2024

(54) OPTIMIZING PRICE BASED ON HISTOGRAM RIGHT HAND SIDE DISTRIBUTION ELASTICITY

(71) Applicant: Price FX Inc., Chicago, IL (US)

(72) Inventor: Alexander Kharlamov, New York, NY (US)

(73) Assignee: Price FX Inc., Chicago, IL (US)

(21) Appl. No.: 18/088,406

(22) Filed: Dec. 23, 2022

(51) Int. Cl. G06Q 30/0283; G06Q 30/0201

(52) U.S. Cl. CPC G06Q 30/0283; G06Q 30/0201

(57) ABSTRACT

A system that optimizes price for a product based on an elasticity model fitted to the right hand side of histogram of normalized price. First, historical transactional data is grouped into segments, each segment containing transactions for a set of mutually similar products and mutually similar customers. Each segment is then processed separately. Selling price in the data is transformed to a normalized metric (e.g., margin percentage or discount percentage). Distribution of the normalized metric is represented with its histogram. Segmentation is done so that the histogram in each segment is unimodal and is well represented by a distribution model A distribution model is fit to the histogram distribution. The right-hand side of the distribution model is then selected, and a right hand side (RHS) elasticity model is fit to the distribution. Optimized selected metric is determined from the fitted model.

### BACKGROUND

Commerce companies have expended a large number of resources into determining the ideal price to maximize their margins and revenue. As part of trying to determine the optimal price, these companies often analyze sales data, and try determining the optimal price for their particular product. Determining the optimal price has proven to be an arduous task for companies trying to maximize their margins. Particularly complicated has been fitting elasticity models, needed for margin optimization, to the sales data. What is needed is a method for optimizing price of a product using an elasticity approach.

### SUMMARY

The present technology, roughly described, optimizes product price based on an elasticity model fitted to the right hand side of histogram of normalized price. First, historical transactional data is grouped into segments, each segment containing transactions for a set of mutually similar products and mutually similar customers. Each segment is then processed separately. Selling price in the data is transformed to a normalized metric (e.g., margin percentage or discount percentage). Distribution of the normalized metric is represented with its histogram. Segmentation is done so that the histogram in each segment is unimodal and is well represented by a distribution model. A distribution model is fit to the histogram distribution. The right-hand side of the distribution model is then selected, and a right hand side (RHS) elasticity model is fit to the distribution. Optimized selected metric is determined from the fitted model.

In some instances, the present technology provides a method for automatically optimizing price of a product based on elasticity model. The method begins by accessing a distribution histogram of historical product sales data, and continues by automatically selecting a distribution model to fit the histogram distribution. Next, a right hand side elasticity model is automatically fit to the right hand side (RHS) of the distribution histogram. The method automatically determines an optimized selected metric from the fitted model. The optimized metrics can be reported to a user.

In some instances, a non-transitory computer readable storage medium includes embodied thereon a program, the program being executable by a processor to perform a method for automatically optimizing price of a product based on distribution elasticity. The method begins by accessing a histogram distribution of historical product data, and continues by automatically selecting a distribution model to fit the histogram distribution. Next, a right hand side model is automatically selected to fit the right hand side (RHS) of the histogram distribution. The selected RHS model is then fit to the histogram distribution model, and the method automatically determines an optimized selected metric from the fitted model. The optimized metrics can be reported to a user.

In some instances, a system for automatically optimizing price of a product based on distribution elasticity includes a server having a memory and a processor. One or more modules can be stored in the memory and executed by the processor to access a histogram distribution of historical product data, automatically select a distribution model to fit the histogram distribution, automatically select a right hand side model to fit the right hand side (RHS) of the histogram distribution, fit the selected RHS model to the histogram distribution model, automatically determine an optimized selected metric from the fitted model, and report the optimized metric to a user.

### BRIEF DESCRIPTION OF FIGURES

FIG. 1 is a block diagram of a system for optimizing price based on right hand side elasticity.

FIG. 2 is a block diagram of an optimization application.

FIG. 3 is a method for optimizing price based on right hand side elasticity.

FIG. 4 is a method for selecting a distribution model to fit a histogram distribution.

FIG. 5 is a method for selecting a right hand side of a histogram distribution.

FIG. 6 illustrates a histogram distribution generated from historical transactional data.

FIG. 7 illustrates a histogram distribution model fit to a RHS model.

FIG. 8 illustrates a price plot and revenue plot based on a histogram distribution model fit to a RHS model.

FIG. 9 provides a computing environment for implementing the present technology.

### DETAILED DESCRIPTION

The present technology optimizes price for a product based on an elasticity model fitted to the right hand side of histogram of normalized price. First, historical transactional data is grouped into segments, each segment containing transactions for a set of mutually similar products and mutually similar customers. Each segment is then processed separately. Selling price in the data is transformed to a normalized metric (e.g., margin percentage or discount percentage). Distribution of the normalized metric is represented with its histogram. Segmentation is done so that the histogram in each segment is unimodal and is well represented by a distribution model. A distribution model is fit to the histogram distribution. The right-hand side of the distribution model is then selected, and a right hand side (RHS) elasticity model is fit to the distribution. Optimized selected metric is determined from the fitted model.

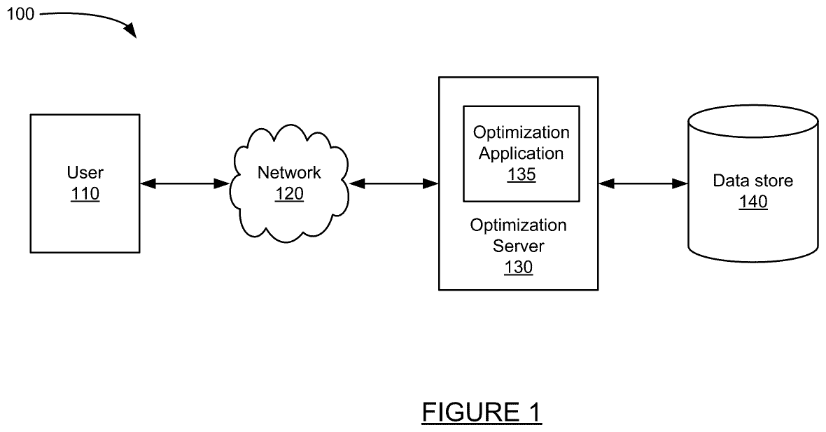

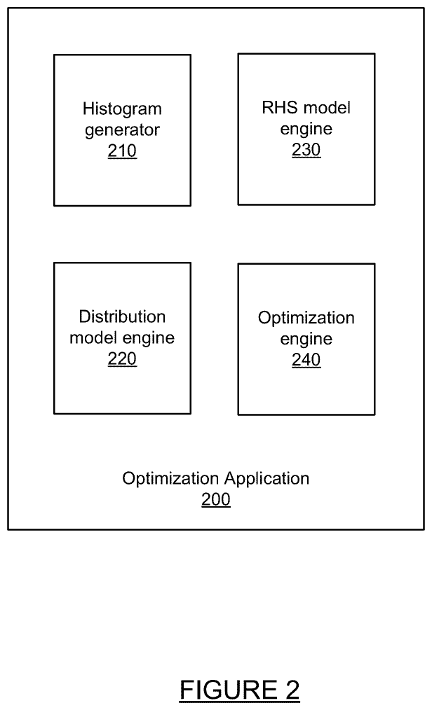

FIG. 1 is a block diagram of a system for optimizing price based on histogram right hand side elasticity. System 100 of FIG. 1 includes user 110, network 120, optimization server 130, and data store 140. Optimization server 130 includes optimization application 135. The optimization application may perform the functionality described herein to optimize price (or some other metric) for a product based on a histogram right-hand side elasticity. The optimization application may generate histograms, generate and fit models to distributions, fit the models together, and otherwise perform optimization functions. More detail for optimization application 135 is discussed with respect to the block diagram of FIG. 2.

Optimization application 135 may receive data, such as historical sales data, from data store 140. Optimization application may also retrieve one or more models from data store 140. In some instances, data store 140 may be implemented by several data stores executing on the same machine or different machines. In some instances, data store 140 may be at least partially, or entirely, implemented on optimization server 130.

Once optimization application has determined an optimized price for a set of historical sales data, a user 110 may access the optimization data from optimization server 130 over network 120. As part of optimizing historical sales data, user 110 may set parameters for the optimization, such as models to use, historical data to use, which metrics to optimize for, and other data.

Network 120 may be implemented by one or more networks suitable for communication between electronic devices, including but not limited to a local area network, wide-area networks, private networks, public network, wired network, a wireless network, a Wi-Fi network, an intranet, the Internet, a cellular network, a plain old telephone service, and any combination of these networks.

FIG. 2 is a block diagram of an optimization application. Optimization application 200 of FIG. 2 may provide more data for optimization application 135 of FIG. 1. Optimization application 200 includes histogram generator 210, distribution model engine 220, RHS model engine 230, and optimization engine 240. Histogram generator 210 may generate a histogram for a set of historical sales transaction data. The histogram generator may retrieve the data, generate the histogram, and store the data locally or remotely.

Distribution model engine 220 may generate a model to fit the distribution of a histogram. In some instances, the model for the histogram distribution may be any one of a normal fit, a log normal fit, or some other fit. Distribution model engine 220 may select a particular model based on the closeness of the fit for each model, such as for example by using the least squares method or chi-squared test.

RHS model engine 230 may fit an elasticity model to a right-hand side of a distribution histogram. The different types of RHS models used by the model engine 230 may include, but are not limited to, an exponential model, a sigmoidal model, or some other model. RHS model engine 230 may select a particular model based on the closeness of the fit for each model, such as for example by determining the fit using a least squares method. The fit may be based on one or more of several methods, such as for example selecting a point on the histogram distribution model associated with the mean and standard deviation.

Optimization engine 240 calculates the optimal normalized metric, such as margin percentage or discount percentage, which ensures optimal profit or revenue.

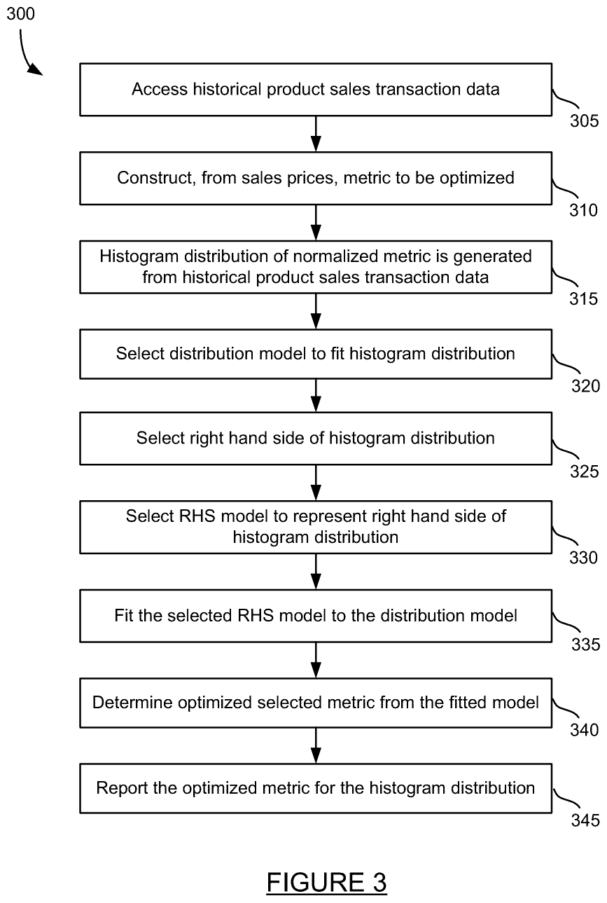

FIG. 3 is a method for optimizing price based on right hand side elasticity. First, historical product sales transaction data is accessed at step 305. A metric to be optimized is constructed from the sales prices at step 310. The metrics selection for which to optimize data may include one of the any metrics, such as for example a margin percentage, markup, or discount. In some instances, a margin percentage may be calculated as the difference of the price and the cost, divided by the price. A markup may be calculated as the difference of a price and the cost, divided by the cost. A discount may be determined by the difference of a reference price and the price, divided by the reference price. A histogram distribution of the normalized metric is then generated from the historical product sales transaction data at step 315.

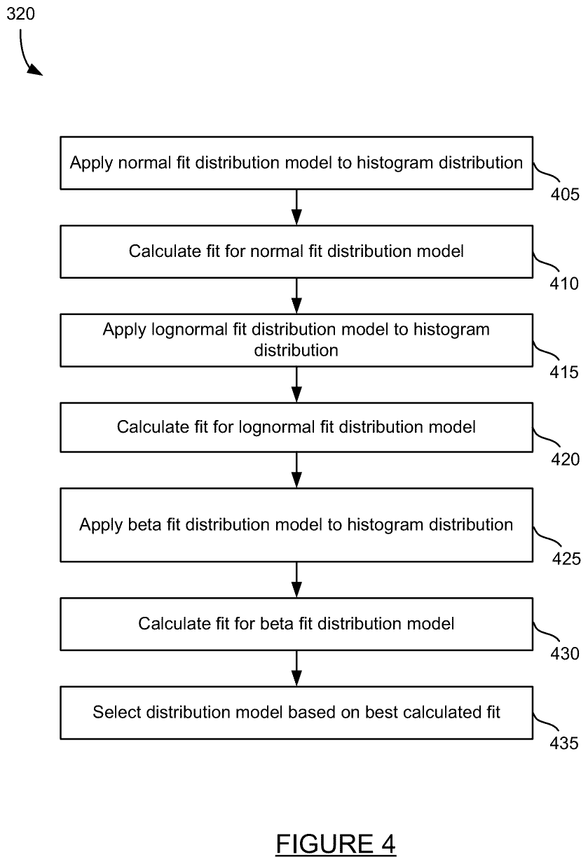

A distribution model is selected to fit the histogram distribution at step 320. The distribution model may be selected as one of many possible types, for example based on its overall fit to the histogram distribution. Selecting a distribution model to fit a histogram distribution is discussed in more detail with respect to the method of FIG. 4. In some instances, the distribution models may not be restricted to those discussed with respect to FIG. 4.

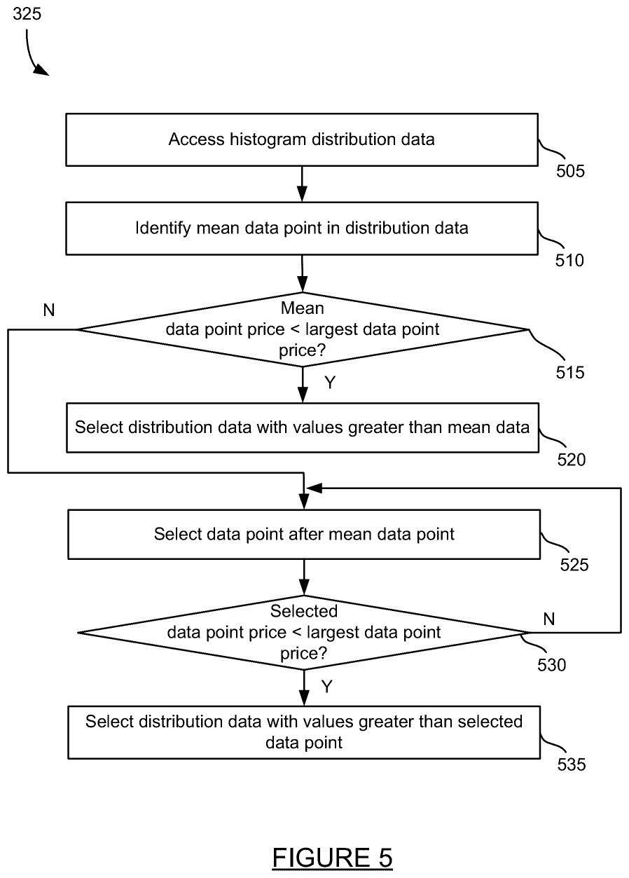

A right-hand side of the histogram distribution is selected at step 325. The right-hand side of the histogram is selected so that a model can be fit to just the right-hand side data of the histogram distribution. More details for selecting the right-hand side of the histogram distribution is discussed with respect to the method of FIG. 5. In case of use of a discount metric, the left hand side of the histogram is used.

After selecting the right-hand side of the histogram, a right-hand side model is selected to represent the right-hand side of the histogram distribution at step 330. The right-hand side model may be an exponential model, sigmoidal model, or some other model connecting the normalized metric and the sold volume. An exponential model may be expressed as:

q=q₀ exp(−A(1+M)), with q₀, A being parameters of the model and M—the normalized metric.

A sigmoidal model may be expressed by the equation:

$$q = \frac{L}{1 + exp ( - k ( x - {x}_{0} )} ,$$

with x₀, k, L being parameters of the model and x—the normalized metric.

A model in terms of the price may be expressed as:

q=q₀ exp(−k·p), with q₀, k being parameters of the model and p—the price.

A price model may be transformed in terms of Margin %. Such a model can be derived through the following model expansion steps:

$$q = {q}_{0} exp ( - k \cdot p ) = {q}_{0} exp ( - \frac{k * c}{1 - M \%} ) , and$$

$${q}_{0} exp ( - \frac{k * c}{1 - M \%} ) = {q}_{0} exp ( - \frac{A}{1 - M \%} ) .$$

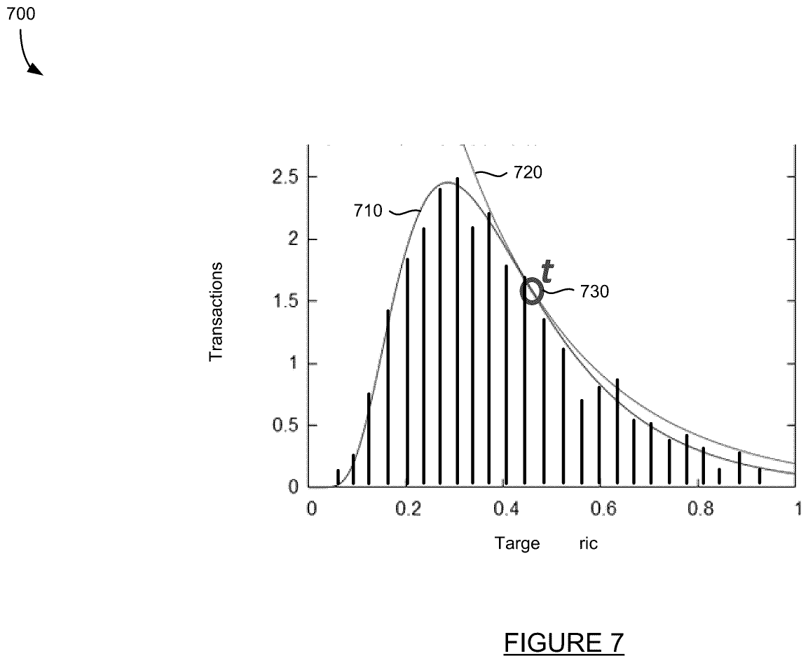

The selected right-hand side model is fit to the distribution model at step 335. Fitting the two models together may include determining which point at which the two models should overlap. In some instances, the models may be fit at a point T located on the right-hand side of the distribution model, and a corresponding horizontal point on the RHS model. In some instances, point T can be equal to the mean plus the standard deviation, or mean plus one divided by two. An example of two functions that overlap in this manner is illustrated with respect to FIG. 7. In some instances, the fit may be performed using a Taylor expansion to the T point at the right-hand side model and ensuring equality for both models of the first two terms of the expansion. Fitting results in a connection between parameters of the RHS model and parameters of the distribution, e.g., mean and standard deviations. An example of an exponential model fitted to a normal distribution equation may be expressed as:

Distribution:

$$q = \frac{1}{s \sqrt{2 π}} \times exp ( \frac{- {( M \% - m )}^{2}}{2 {s}^{2}} ) = \frac{1}{s \sqrt{2 π}} exp ( \frac{- {( t - m )}^{2}}{2 {s}^{2}} ) - \frac{( t - m )}{{s}^{3} \sqrt{2 π}} exp ( \frac{- {( t - m )}^{2}}{2 {s}^{2}} ) ( M \% - t ) + …$$

### Model:

$$q = q 0 exp ( \frac{- A}{1 - M \%} ) = exp ( \frac{- A}{1 - t} ) q 0 - \frac{exp ( \frac{- A}{1 - t} ) A q 0 ( M \% - t )}{{( 1 - t )}^{2}} + …$$

resolving to

$$A ( t , m , s ) = \frac{( t - m ) {( 1 - t )}^{2}}{{s}^{2}}$$

and

$$q 0 ( t , m , s ) = \frac{1}{s \sqrt{2 π}} exp ( \frac{( t - m ) ( m + 2 - 3 t )}{2 {s}^{2}} )$$

An optimized selected metric is then determined from the fitted model at step 340. The optimized selected metrics may be revenue, profit, a mix of optimized revenue and profit, or some other metrics. An example of an equation for selecting optimize profit is given by:

Profit

$$π = q ( p - c ) = \frac{qcM \%}{1 - M \%} = q 0 exp ( \frac{- A}{1 - M \%} ) \frac{cM \%}{1 - M \%} ,$$

While optimized margin percentage is given as:

$$M {\%}_{opt} = \frac{1}{A + 1} = \frac{1}{\frac{( t - m ) {( 1 - t )}^{2}}{{s}^{2}} + 1}$$

where t point is located somewhere on the right-hand side of the distribution, e.g., t=m+s or t=(m+1)/2

The optimized metric value for the histogram distribution is reported at step 345. Reporting may be performed through a dashboard, interface, a table of data, or in some other format.

FIG. 4 is a method for selecting a distribution model to fit a histogram distribution. The method of FIG. 4 provides more detail for step 320 of the method of FIG. 3. First, a normal fit distribution model is applied to the histogram distribution at step 405. The goodness of fit is calculated for the normal fit distribution model at step 410. The goodness of fit may be determined by the chi-square method or some other method. The goodness of fit and distribution model are then stored in memory.

A lognormal fit distribution model is applied to the histogram distribution at step 415. The goodness of fit for the lognormal fit distribution model is calculated at step 420. After storing the goodness of fit for the lognormal fit distribution model, a beta fit distribution model is applied to the histogram distribution at step 425. The goodness of fit for the beta fit distribution model is calculated at step 430. Other distributions may be tested with the same approach. The distribution model having the best calculated fit is selected at step 435.

FIG. 5 is a method for selecting a right hand side of a histogram distribution. The method of FIG. 5 provides more detail for step 325 of the method of FIG. 3A histogram distribution data is accessed at step 505. A mean data point is identified in the distribution data at step 510. A determination is made as to whether the mean data point is less than the largest data point on the distribution at step 515. If the mean data point is less than the largest data point, the distribution data with values greater than the mean data is selected at step 520.

If the data point is larger at step 515, a data point somewhere after the mean data point is selected at step 525. The selected data point after the mean data point can be the next data point or any data point thereafter. A determination is then made at step 530 as to whether the selected data point price is less than the largest data point price. If the selected data point price is less than the largest data point price, distribution data is selected with values greater than the selected data at step 535. If the selected data point is greater than the largest data point, the method of FIG. 5 returns to step 525 where a new selected data point after the mean data point is selected.

In some instances, selecting a right hand side of a histogram distribution may include selecting data greater having a value greater than the mean data point. The mean data point can be at most equal to the maximum data point. In some instances, this can be implemented as a degenerate case when normalized metric is equal to the same number of all transactions of the segment. Such cases may not allow for optimization, and some price variability can be implemented.

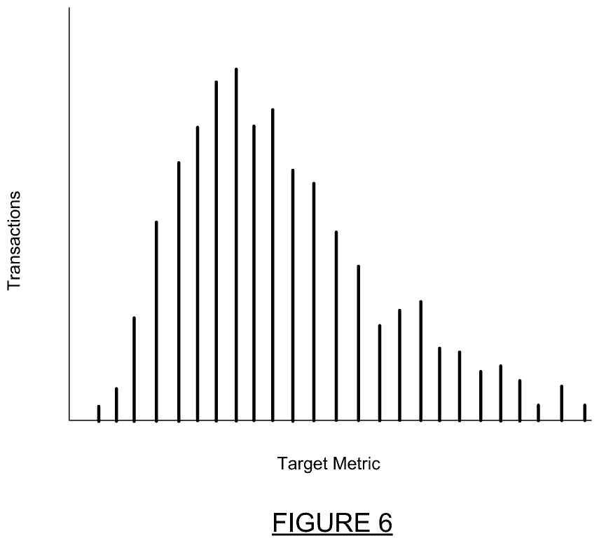

FIG. 6 illustrates a histogram distribution generated from historical transactional data. The histogram distribution plots the normalized metric versus the number of transactions. In some instances, the normalized metric may be margin percentage, markup percentage or discount percentage. As shown, the histogram distribution has fewer plotted values before the highest point then after, and there is a longer trail of decreased plotted points after the maximum normalized metric value. The shape of the histogram distribution in FIG. 6, in some instances, can be better fit with a lognormal distribution as compared to a normal distribution.

FIG. 7 illustrates a histogram distribution model fit to a RHS model. As shown, a distribution model 710 is applied to the entire spectrum of the histogram distribution, with the distribution not exceeding the height of the highest distribution value. A right-hand side model 720 is applied to the right-hand side of the distribution. A point T is selected on the distribution that is roughly equivalent to the mean of the distribution plus the first standard deviation. The right-hand side model is then fit to overlap the distribution model at that same point.

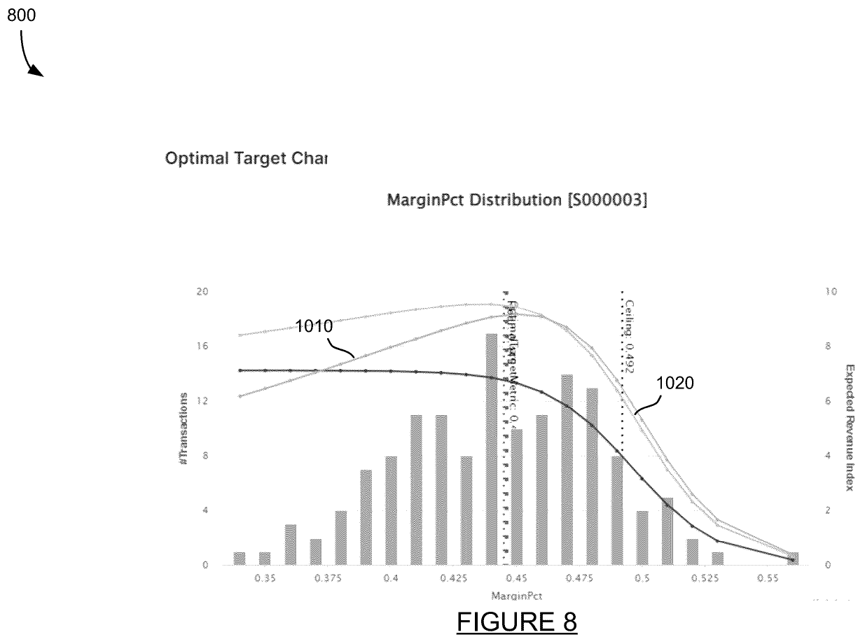

FIG. 8 illustrates a price plot and revenue plot based on a histogram distribution

model fit to a RHS model. Once the models are fitted together, as shown in FIG. 7, plots for other metrics may be determined for a histogram distribution, including plots for revenue and plots for profit. In FIG. 8, plot 1010 represents revenue and plot 1020 represents revenue. The maximum revenue may be selected by taking the highest point of plot 1010. The maximum profit may be selected by taking the highest point of plot 1020. Each plot may be derived from the right-hand side model that was fit to the histogram distribution.

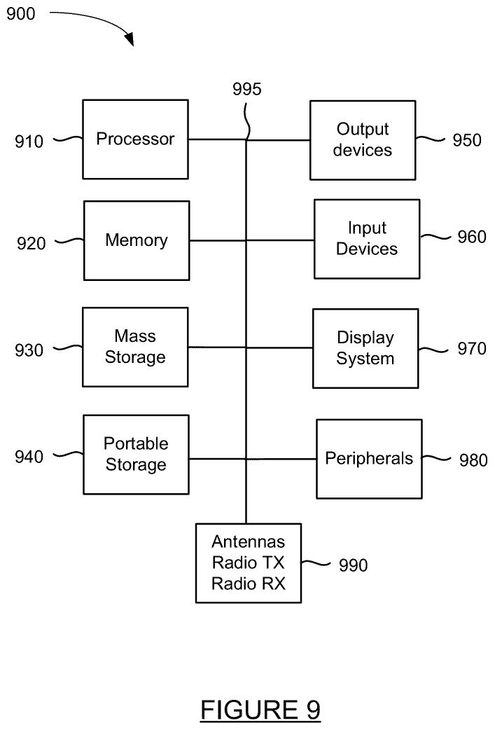

FIG. 9 is a block diagram of a computing environment for implementing the present technology. System 900 of FIG. 9 may be implemented in the contexts of the likes of machines that implement detection system sensory 120, data stores 135 and 140, processing engine 145, alert engine 150, response engine 155, and network application 160. The computing system 900 of FIG. 9 includes one or more processors 910 and memory 920. Main memory 920 stores, in part, instructions and data for execution by processor 910. Main memory 920 can store the executable code when in operation. The system 900 of FIG. 9 further includes a mass storage device 930, portable storage medium drive(s) 940, output devices 950, user input devices 960, a graphics display 970, and peripheral devices 980.

The components shown in FIG. 9 are depicted as being connected via a single bus 990. However, the components may be connected through one or more data transport means. For example, processor unit 910 and main memory 920 may be connected via a local microprocessor bus, and the mass storage device 930, peripheral device(s) 980, portable storage device 940, and display system 970 may be connected via one or more input/output (I/O) buses.

Mass storage device 930, which may be implemented with a magnetic disk drive, an optical disk drive, a flash drive, or other device, is a non-volatile storage device for storing data and instructions for use by processor unit 910. Mass storage device 930 can store the system software for implementing embodiments of the present invention for purposes of loading that software into main memory 920.

Portable storage device 940 operates in conjunction with a portable non-volatile storage medium, such as a floppy disk, compact disk or Digital video disc, USB drive, memory card or stick, or other portable or removable memory, to input and output data and code to and from the computer system 900 of FIG. 9. The system software for implementing embodiments of the present invention may be stored on such a portable medium and input to the computer system 900 via the portable storage device 940.

Input devices 960 provide a portion of a user interface. Input devices 960 may include an alpha-numeric keypad, such as a keyboard, for inputting alpha-numeric and other information, a pointing device such as a mouse, a trackball, stylus, cursor direction keys, microphone, touchscreen, accelerometer, and other input devices. Additionally, the system 900 as shown in FIG. 9 includes output devices 950. Examples of suitable output devices include speakers, printers, network interfaces, and monitors.

Display system 970 may include a liquid crystal display (LCD) or other suitable display device. Display system 970 receives textual and graphical information and processes the information for output to the display device. Display system 970 may also receive input as a touch-screen.

Peripherals 980 may include any type of computer support device to add additional functionality to the computer system. For example, peripheral device(s) 980 may include a modem or a router, printer, and other device.

The system of 900 may also include, in some implementations, antennas, radio transmitters and radio receivers 990. The antennas and radios may be implemented in devices such as smart phones, tablets, and other devices that may communicate wirelessly. The one or more antennas may operate at one or more radio frequencies suitable to send and receive data over cellular networks, Wi-Fi networks, commercial device networks such as a Bluetooth device, and other radio frequency networks. The devices may include one or more radio transmitters and receivers for processing signals sent and received using the antennas.

The components contained in the computer system 900 of FIG. 9 are those typically found in computer systems that may be suitable for use with embodiments of the present invention and are intended to represent a broad category of such computer components that are well known in the art. Thus, the computer system 900 of FIG. 9 can be a personal computer, handheld computing device, smart phone, mobile computing device, workstation, server, minicomputer, mainframe computer, or any other computing device. The computer can also include different bus configurations, networked platforms, multi-processor platforms, etc. Various operating systems can be used including Unix, Linux, Windows, Macintosh OS, Android, as well as languages including Java, .NET, C, C++, Node.JS, and other suitable languages.

The foregoing detailed description of the technology herein has been presented for purposes of illustration and description. It is not intended to be exhaustive or to limit the technology to the precise form disclosed. Many modifications and variations are possible in light of the above teaching. The described embodiments were chosen to best explain the principles of the technology and its practical application to thereby enable others skilled in the art to best utilize the technology in various embodiments and with various modifications as are suited to the particular use contemplated. It is intended that the scope of the technology be defined by the claims appended hereto.

What is claimed is:

1. A method for automatically optimizing price of a product based on distribution elasticity, comprising:
accessing a histogram distribution of historical product data;
automatically selecting a distribution model to fit the histogram distribution;
automatically selecting a right hand side model to fit the right hand side (RHS) of the histogram distribution;
fitting the selected RHS model to the histogram distribution model;
automatically determining an optimized selected metric from the fitted model; and
reporting the optimized metric to a user.

2. The method of claim 1, wherein the distribution model is a lognormal distribution model.

3. The method of claim 1, further comprising:
selecting a portion of the distribution data greater than the mean, wherein the right hand side of the histogram model includes the portion of the histogram distribution that is greater than the mean; and
fitting the selected model to the portion of data greater than the mean.

4. The method of claim 1, wherein fitting the selected RHS model and the histogram model includes fitting the models to a two dimensional point.

5. The method of claim 4, wherein the two dimensional point is defined by the sum of a mean and a first standard deviation in the distribution model.

6. The method of claim 1, wherein fitting includes using a Taylor series expansion

7. The method of claim 1, wherein automatically determining an optimized selected metric from the fitted model includes deriving a distribution model for the selected metric from the fitted RHS model.

9. A non-transitory computer readable storage medium having embodied thereon a program, the program being executable by a processor to perform a method for automatically optimizing price of a product based on distribution elasticity, the method comprising:
accessing a histogram distribution of historical product data;
automatically selecting a distribution model to fit the histogram distribution;
automatically selecting a right hand side model to fit the right hand side (RHS) of the histogram distribution;
fitting the selected RHS model to the histogram distribution model;
automatically determining an optimized selected metric from the fitted model; and
reporting the optimized metric to a user.

10. The non-transitory computer readable storage medium of claim 9, wherein the distribution model is a normal, beta, lognormal or another distribution model.

11. The non-transitory computer readable storage medium of claim 9, further comprising:
selecting a portion of the distribution data greater than the mean, wherein the right hand side of the histogram model includes the portion of the histogram distribution that is greater than the mean; and
fitting the selected model to the portion of data greater than the mean.

12. The non-transitory computer readable storage medium of claim 9, wherein fitting the selected RHS model and the histogram model includes fitting the models to a two dimensional point.

13. The non-transitory computer readable storage medium of claim 12, wherein the two dimensional point is defined by the sum of a mean and a first standard deviation in the distribution model.

14. The non-transitory computer readable storage medium of claim 9, wherein fitting includes using a Taylor series expansion.

15. The non-transitory computer readable storage medium of claim 9, wherein automatically determining an optimized selected metric from the fitted model includes deriving a distribution model for the selected metric from the fitted RHS model.

16. A system for automatically optimizing price of a product based on distribution elasticity, comprising:
a server including a memory and a processor; and
one or more modules stored in the memory and executed by the processor to access a histogram distribution of historical product data, automatically select a distribution model to fit the histogram distribution, automatically select a right hand side model to fit the right hand side (RHS) of the histogram distribution, fit the selected RHS model to the histogram distribution model, automatically determine an optimized selected metric from the fitted model, and report the optimized metric to a user.

17. The system of claim 16, wherein the distribution model is a normal, lognormal, beta of any other distribution model.

18. The system of claim 16, further comprising:
selecting a portion of the distribution data greater than the mean, wherein the right hand side of the histogram model includes the portion of the histogram distribution that is greater than the mean; and
fitting the selected model to the portion of data greater than the mean.

19. The system of claim 16, wherein fitting the selected RHS model and the histogram model includes fitting the models to a two dimensional point.

20. The system of claim 16, wherein the two dimensional point is defined by the sum of a mean and a first standard deviation in the distribution model.
